(19) United States
(12) Patent Application Publication
(10) Pub. No.: US 2003/0120478 A1
(43) Pub. Date: Jun. 26, 2003

(54) Network-based translation system

(76) Inventor: Robert Palmquist, Faribault, MN (US)

Correspondence Address: SHUMAKER & SIEFFERT, P. A., 8425 SEASONS PARKWAY, SUITE 105, ST. PAUL, MN, 55125, US

(21) Appl. No.: 10/026,293

(22) Filed: Dec. 21, 2001

(51) Int. Cl. G06F 17/28

(52) U.S. Cl. 704/3; 715/536

(57) ABSTRACT

The invention provides techniques for translation of written languages using a network. A user captures the text of interest with a client device and transmits the image over the network to a server. The server recovers the text from the image, generates a translation, and transmits the translation over the network to the client device. The client device may also support techniques for editing the image to retain the text of interest and excise extraneous matter from the image.

### TECHNICAL FIELD

The invention relates to electronic communication, and more particularly, to electronic communication with language translation.

### BACKGROUND

The need for real-time language translation has become increasingly important. It is becoming more common for a person to encounter foreign language text. Trade with a foreign company, cooperation of forces in a multi-national military operation in a foreign land, emigration and tourism are just some examples of situations that bring people in contact with languages with which they may be unfamiliar.

In some circumstances, the written language barrier presents a very difficult problem. An inability to understand directional signs, street signs or building name plates may result in a person becoming lost. An inability to understand posted prohibitions or danger warnings may result in a person engaging in illegal or hazardous conduct. An inability to understand advertisements, subway maps and restaurant menus can result in frustration.

Furthermore, some written languages are structured in a way that makes it difficult to look up the meaning of a written word. Chinese, for example, does not include an alphabet, and written Chinese includes thousands of picture-like characters that correspond to words and concepts. An English-speaking traveler encountering Chinese language text may find it difficult to find the meaning of a particular character, even if the traveler owns a Chinese-English dictionary.

### SUMMARY

In general, the invention provides techniques for translation of written languages. A user captures the text of interest with a client device, which may be a handheld computer, for example, or a personal digital assistant (PDA). The client device interacts with a server to obtain a translation of the text. The user may use an image capture device, such as a digital camera, to capture the text. The digital camera may be integrated or coupled to the client device.

In many cases, an image captured in this way includes not only the text of interest, but extraneous matter. The invention provides techniques for editing the image to retain the text of interest and excise the extraneous matter. One way for the user to edit the image is to display the image on a PDA and circle the text of interest with a stylus. When the image is edited, the user may translate the text in the image right away, or save the image for later translation.

To obtain a translation of the text in one or more images, the user commands the client device to obtain a translation. The client device establishes a communication connection with a server over a network, and transmits the images in a compressed format to the server. The server extracts the text from the images using optical character recognition software, and translates the text with a translation program. The server transmits the translations back to the client device. The client device may display an image of text and the corresponding translation simultaneously. The client device may further display other images and corresponding translations in response to commands from the user.

In one embodiment, the invention presents a method comprising transmitting an image containing text in a first language over a network, and receiving a translation of the text in a second language over the network. The image may be captured with an image capture device and edited prior to transmission. After the translation is received, the image and the translation may be displayed simultaneously.

In another embodiment, the invention is directed to a method comprising receiving an image containing text in a first language over a network, translating the text to a second language and transmitting the translation over the network. The method may further include extracting the text from the image with optical character recognition.

In another embodiment, the invention is directed to a client device comprising image capture apparatus that receives an image containing text in a first language, and a transmitter that transmits the image over a network and a receiver that receives a translation of the text in a second language over the network. The device may also include a display that displays the translation and the image. The device may further comprise a controller that edits the image in response to the commands of a user. In some implementations, the device may include an image capture device, such as a digital camera, or a cellular telephone that establishes a communication link between the device and the network.

In a further embodiment, the invention is directed to a server device comprising a receiver that receives an image containing text in a first language over a network, a translator that generates a translation of the text in a second language and a transmitter that transmits the translation over the network. The device may also include a controller that selects which of many translators to use and an optical character recognition module that extracts the text from the image.

The invention offers several advantages. The client device and the server cooperate to use the features of modem, fully-featured translation programs. When the client device is wirelessly coupled to the network, the user is allowed expanded mobility without sacrificing performance. The client device may be configured to work with any language and need not be customized to any particular language. Indeed, the client device processes image-based text, leaving the recognition and translation functions to the server. Furthermore, the invention is especially advantageous when the language is so unfamiliar that it would not be possible for a user to look up words in a dictionary.

The invention also supports editing of image data prior to transmission to remove extraneous data, thereby saving communication time and bandwidth. The invention can save more time and bandwidth by transmitting several images for translation at one time.

The user interface offers several advantages as well. In some embodiments, the user can easily edit the image to remove extraneous material. The user interface also supports display of one or more images and the corresponding translations. Simultaneous display of an image of text and the corresponding translation lets the user associate the text to the meaning that the text conveys.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a diagram illustrating an embodiment of a network-based translation system.

FIG. 2 is a functional block diagram illustrating an embodiment of a network-based translation system.

FIG. 3 is an exemplary user interface illustrating image capture and editing.

FIG. 4 is an exemplary user interface further illustrating image capture and editing, and illustrating commencement of interaction between client and server.

FIG. 5 is an exemplary user interface illustrating a translation display.

FIG. 6 is a flow diagram illustrating client-server interaction.

### DETAILED DESCRIPTION

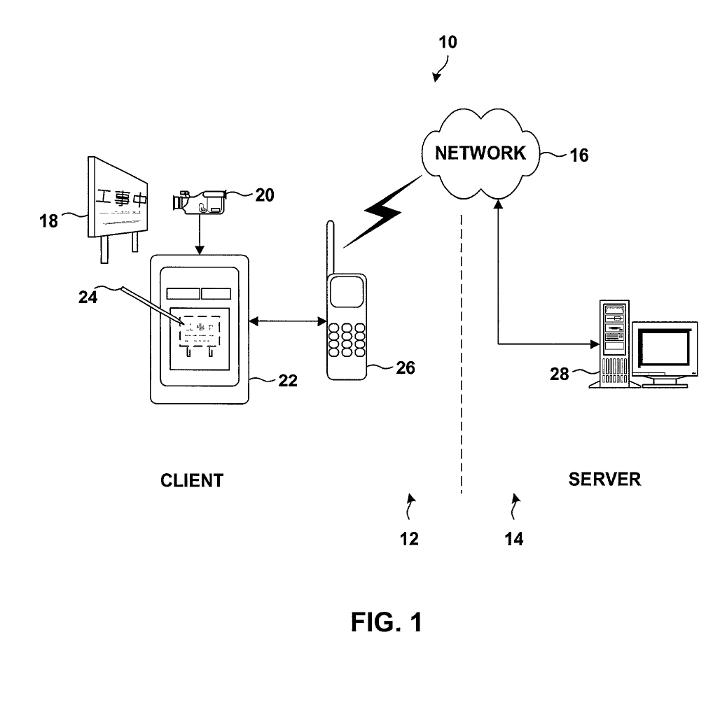

FIG. 1 is a diagram illustrating an image translation system 10 that may be employed by a user. System 10 comprises a client side 12 and server side 14, separated from each other by communications network 16. System 10 receives input in the form of images of text. The images of text may be obtained from any number of sources, such as a sign 18. Other sources of text may include building name plates, advertisements, maps and printed documents.

In one embodiment, system 10 receives text image input with an imager capture device such as a camera 20. Camera 20 may be, for example, a digital camera, such as a digital still camera or a digital motion picture camera. The user directs camera 20 at the text the user desires to translate, and captures the text in a still image. The image may be displayed on a client device such as a display device 22 coupled to camera 20. Display device 22 may comprise, for example, a hand-held computer or a personal digital assistant (PDA).

Often, a captured image includes the text that the user desires to translate, along with extraneous material. A user who has captured the text on a public marker, for example, may capture the main caption and the explanatory text, but the user may be interested only in the main caption of the marker. Accordingly, display device 22 may include a tool for editing the captured image to isolate the text of interest. An editing tool may include a cursor-positionable selection box or a selection tool such as a stylus 24. The user selects the desired text by, for example, lassoing or drawing a box around the desired text with the editing tool. The desired text is then displayed on display device 22.

When the user desires to translate the text, the user selects the option that begins translation. Display device 22 compresses the image for transmission. Display device 22 may compress the image as a JPEG file, for example. Display device 22 may further include a modem or other encoding/decoding device to encode the compressed image for transmission.

Display device 22 may be coupled to a communication device such as a cellular telephone 26. Alternatively, display device 22 may include an integrated wireless transceiver. The compressed image is transmitted via cellular telephone 26 to server 28 via network 16. Network 16 may include, for example, a wireless telecommunication network such as a network implementing Bluetooth, a cellular telephone network, the public switched telephone network, an integrated digital services network, satellite network or the Internet, or any combination thereof.

Server 28 receives the compressed image that includes the text of interest. Server 28 decodes the compressed image to recover the image, and retrieves the text from the image using any of a variety of optical character recognition (OCR) techniques. OCR techniques may vary from language to language, and different companies may make commercially available OCR programs for different languages. After retrieving the text, server 28 translates the recognized characters using any of a variety of translation programs. Translation, like OCR, is language-dependent, and different companies may make commercially available translation programs for different languages. Server 28 transmits the translation to cellular telephone 26 via network 16, and cellular telephone 26 relays the translation to display device 22.

Display device 22 displays the translation. For the convenience of the user, display device 22 may simultaneously display, in thumbnail or full-size format, the image that includes the translated text. The displayed image may be the image retained by display device 22, rather than an image received from server 28. In other words, server 28 may transmit the translation unaccompanied by any image data. Because the image data may be retained by display device 22, there is no need for server 28 to transmit any image data back to the user, conserving communication bandwidth and resources.

System 10 depicted in FIG. 1 is exemplary, and the invention is not limited to the particular system shown. The invention encompasses components coupled wirelessly as well as components coupled by hard wire. Camera 20 represents one of many devices that capture an image, and the invention is not limited to use of any particular image capture device. Furthermore, cellular telephone 26 represents one of many devices that can provide an interface to communications network 16, and the invention is not limited to use of a cellular telephone.

Furthermore, the functions of display device 22, camera 20 and/or cellular telephone 26 may be combined in a single device. A cellular telephone, for example, may include the functionality of a PDA, or a handheld computer may include a built-in camera and a built-in cellular telephone. The invention encompasses all of these variations.

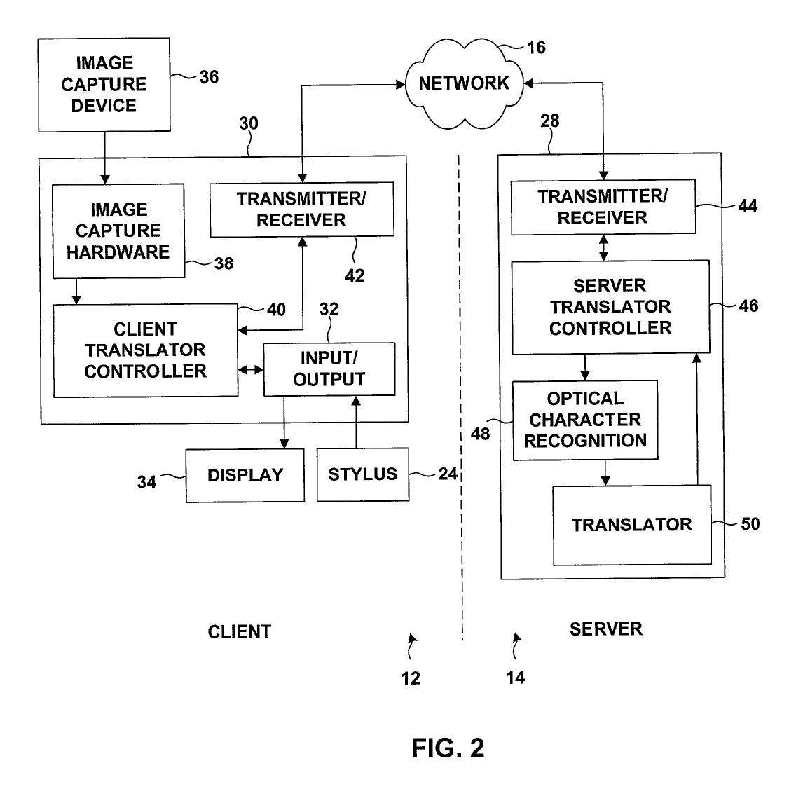

FIG. 2 is a functional block diagram of an embodiment of the invention. On client side 12, the user interacts with client device 30 through an input/output interface 32. In a client device such as a PDA, the user may interact with client device 30 via input/output devices such as a display 34 or stylus 24. Display 34 may take the form of a touchscreen. The user may also interact with client device 30 via other input/output devices, such as a keyboard, mouse, touch pad, push buttons or audio input/output devices.

The user further interacts with client device 30 via image capture device 36 such as camera 20 shown in FIG. 1. With image capture device 36, the user captures an image that includes the text that the user wants to translate. Image capture hardware 38 is the apparatus in client device 30 that receives image data from image capture device 36.

Client translator controller 40 displays the captured image on display 34. The user may edit the captured image using an editing tool such as stylus 24. In some circumstances, an image may include text that the user wants to translate and extraneous information. The user may edit the captured image to preserve the text of interest and to remove extraneous material. The user may also edit the captured image to adjust factors such as the size of the image, contrast or brightness. Client translator controller 40 edits the image in response to the commands of the user and displays the edited image on display 34. Client translator controller 40 may receive and edit several images, displaying the images in response to the commands of the user.

In response to a command from the user to translate the text in one or more of the images, client translator controller 40 establishes a connection with network 16 and server 28 via transmitter/receiver 42. Transmitter/receiver 42 may include an encoder that compresses the images for transmission. Transmitter/receiver 42 transmits the image data to server 28 via network 16. Client translator controller 40 may include data in addition to image data in the transmission, such as an identification of the source language as specified by the user.

Network 16 includes a transmitter/receiver 44 that receives and decodes the image data. A server translator controller 46 receives the decoded image data and controls the translation process. An optical character recognition module 48 receives the image data and recovers the characters from the image data. The recovered data are supplied to translator 50 for translation. In some servers, recognition and translation may be combined in a single module. Translator 50 supplies the translation to server translator controller 46, which transmits the translation to client device 30 via transmitter/receiver 44 and network 16. Client device 30 receives the translation and displays the translation on display 34.

Server 28 may include several optical character recognition modules and translators. Server 28 may include separate optical character recognition modules and translators for Japanese, Arabic and Russian, for example. Server translator controller 46 selects which optical character recognition module and translator are appropriate, based upon the source language specified by the user.

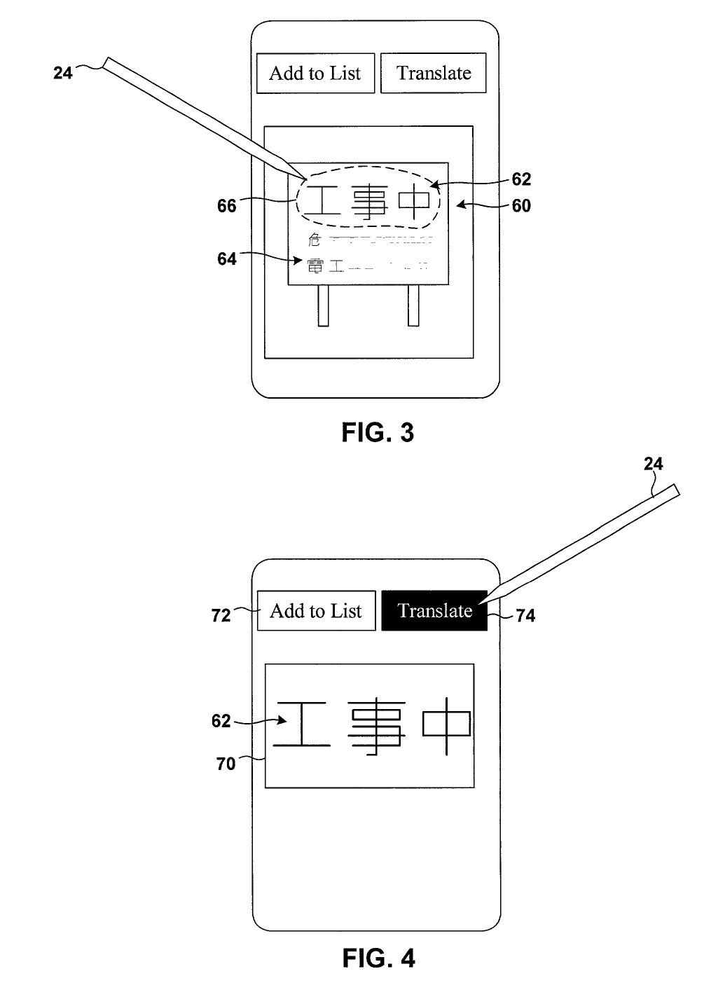

FIG. 3 is an exemplary user interface on client device 30, such as display device 22, following capture of an image 60. Image 60 includes text of interest 62 and other extraneous material 64, such as other text, a picture of a sign, and the environment around the sign. The extraneous material is not of immediate interest to the user, and may delay or interfere with the translation of text of interest 62. The user may edit image 60 to isolate text of interest 62 by, for example, tracing a loop 66 around text of interest 62. Client device 30 edits the image to show the selected text 62.

FIG. 4 is an exemplary user interface on client device 30 following editing of image 60. Edited image 70 includes text of interest 62, without the extraneous material. Edited image 70 may also include an enlarged version of text of interest 62, and may have altered contrast or brightness to improve readability.

Client device 30 may provide the user with one or more options in regard to text of interest 62. FIG. 4 shows two exemplary options, which may be selected with stylus 24. One option 72 adds selected text 62 to a list of other images including other text of interest. In other words, the user may store a plurality of text-containing images for translation, and may have any or all of them translated when a connection to server 28 is established.

Another option is a translation option 74, which instructs client device 30 to begin the translation process. Upon selection of translation option 74, client device 30 may present the user with a menu of options. For example, if several text-containing images have been stored in the list, client device 30 may prompt user to specify which of the images are to be translated.

Client device 30 may further prompt the user to provide additional information. Client device 30 may prompt the user for identifying information, such as an account number, a credit card number or a password. The user may be prompted to specify the source language, i.e. the language of the text to be translated, and the target language, i.e., the language with which the user is more familiar. In some circumstances, the user may be prompted to specify the dictionaries to be used, such as a personal dictionary or a dictionary of military or technical terms. The user may also be asked to provide a location of server 28, such as a network address or telephone number, or the location or locations to which the translation should be sent. Some of the above information, once entered, may be stored in the memory of client device 30 and need not be entered anew each time translation option 74 is selected.

When the user gives the instruction to translate, client device 30 establishes a connection to server 28 via transmitter/receiver 42 and network 16. Server 28 performs the optical character recognition and the translation, and sends the translation back to client device 30. Client device 30 may notify the user that the translation is complete with a cue such as a visual prompt or an audio announcement.

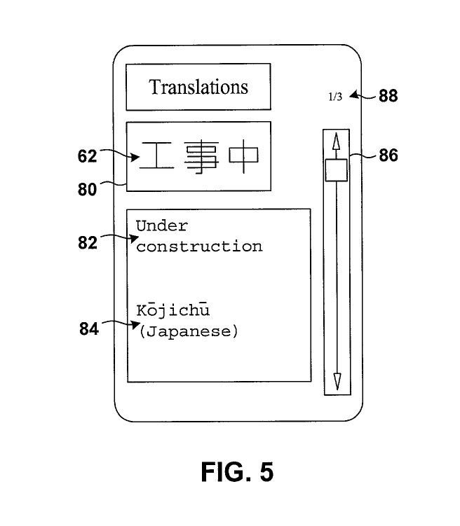

FIG. 5 is an exemplary user interface on client device 30 following translation. For the convenience of the user, client device 30 may display a thumbnail view 80 of the image that includes the translated text. Client device 30 may also display a translation of the text 82. Client device 30 may further provide other information 84 about the text, such as the English spelling of the foreign words, phonetic information or alternate meanings. A scroll bar 86 may also be provided, allowing the user to scroll through the list of images and their respective translations. An index 88 may be displayed showing the number of images for which translations have been obtained.

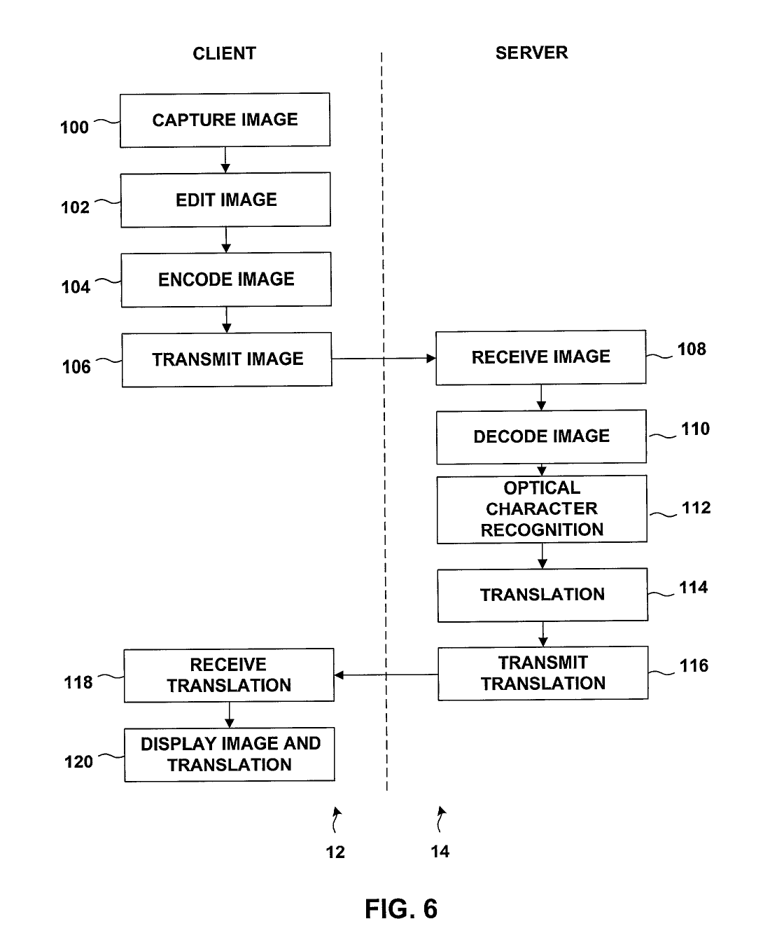

FIG. 6 is a flow diagram illustrating an embodiment of the invention. On client side 12, client device 30 captures an image (100) and edits the image (102) according to the commands of the user. In response to the command of the user to translate the text in the image, client device 30 encodes the image (104) and transmits the image (106) to server 28 via network 16.

On server side 14, server 28 receives the image (108) and decodes the image (110). Server 28 extracts the text from the image with optical character recognition module 48 (112) and translates the extracted text (114). Server 28 transmits the translation (116) to client device 30. Client device 30 receives the translation (118) and displays the translation along with the image (120).

The invention can provide one or more advantages. By performing optical character recognition and translation on server side 14, the user receives the benefit of the translation capability of the server, such as the most advanced versions of optical character recognition software and the most fully-featured translation programs. The user further has the benefit of multi-language capability. A particular server may be able to recognize and translate several languages, or the user may use network 16 to access any of a number of servers that can recognize and translate different languages. The user may also have the choice of accessing a nearby server or a server that is remote. Client device 30 is therefore flexible and need not be customized to any particular language. Image capture device 36 likewise need not be customized for translation, or for any particular language.

The invention may be used with any source language, but is especially advantageous for a user who wishes to translate written text in a completely unfamiliar written language. An English-speaking user who sees a notice in Spanish, for example, can look up the words in a dictionary because the English and Spanish alphabets are similar. An English-speaking user who sees a notice in Japanese, Chinese, Arabic, Korean, Hebrew or Cyrillic, however, may not know how to look up the words in a dictionary. The invention provides a fast and easy to obtain translations even when the written language is totally unfamiliar.

Furthermore, the communication between client side 12 and server side 14 is efficient. Image data from client side 12 may be edited prior to transmission to remove extraneous data. The edited image is usually compressed to further save communication time and bandwidth. Translation data from server side 14 need not include images, which further saves time and bandwidth. Conservation of time and bandwidth reduces the cost of communicating between client device 30 and server 28. Client device 30 further reduces costs by saving several images for translation, and transmitting the images in a batch to server 28.

The user interface offers several advantages as well. The editing capability of client device 30 lets the user edit the image directly. The user need not edit the image indirectly, such as by adjusting the field of view of camera 20 until only the text of interest is captured. The user interface is also advantageous in that the image is displayed with the translation, allowing the user to compare the text that the user sees to the text shown on display 34.

Although the invention encompasses hard line and wireless connections of client device 30 to network 16, wireless connections are advantageous in many situations. A wireless connection allows travelers, such as tourists, to be more mobile, seeing sights and obtaining translations as desired.

Including recognition and translation functionality on server side 14 also benefits travelers by saving weight and bulk on client side 12. Client device 30 and image capture device 36 may be small and lightweight. The user need not carry any specialized client side equipment to accommodate the idiosyncrasies any particular written language. The equipment on the client side works with any written language.

Several embodiments of the invention have been described. Various modifications may be made without departing from the scope of the invention. For example, server 28 may provide additional functionality such as recognizing the source language without a specification of a source language by the user. Server 28 may send back the translation in audio form, as well as in written form.

Cellular phone 26 is shown in FIG. 1 as an interface to network 16. Although cellular phone 26 is not needed for an interface to every communications network, the invention can be implemented in a cellular telephone network. In other words, a cellular provider may provide visual language translation services in addition to voice communication services. These and other embodiments are within the scope of the following claims.

1. A method comprising:
transmitting an image containing text in a first language over a network; and
receiving a translation of the text in a second language over the network.

2. The method of claim 1, wherein the image is a second image, the method further comprising:
capturing a first image containing the text in the first language;
receiving instructions to edit the first image; and
editing the first image to generate the second image in response to the instructions.

3. The method of claim 1, further comprising displaying the image.

4. The method of claim 1, further comprising displaying the image and displaying the translation of the text in the second language simultaneously.

5. The method of claim 1, further comprising establishing a wireless connection with the network.

6. The method of claim 1, wherein the image is a first image containing first text, the method further comprising:
transmitting a second image containing second text in the first language over the network; and
receiving a translation of the first text and the second text in the second language over the network.

7. The method of claim 6, further comprising transmitting the first image and the second image over a network in response to a single command from a user.

8. The method of claim 6, further comprising displaying one of the translation of the first text and the translation of the second text in response to a command from a user.

9. The method of claim 1, further comprising compressing the image.

10. The method of claim 1, further comprising receiving the image from an image capture device.

11. The method of claim 1, further comprising prompting a user to provide additional information comprising at least one of an account number, a password, an identification of the first language, an identification of the second language, a dictionary and a server location.

12. The method of claim 1, wherein the network comprises at least one of a wireless telecommunication network, a cellular telephone network, a public switched telephone network, an integrated digital services network, a satellite network and the Internet.

13. A method comprising:
receiving an image containing text in a first language over a network;
translating the text to a second language; and
transmitting the translation over the network.

14. The method of claim 13, further comprising extracting the text from the image with optical character recognition.

15. The method of claim 13, further comprising receiving a specification of the first language.

16. A device comprising:
an image capture apparatus that receives an image containing text in a first language;
a transmitter that transmits the image over a network; and
a receiver that receives a translation of the text in a second language over the network.

17. The device of claim 16, further comprising a display that displays the translation.

18. The device of claim 16, further comprising a display that displays the translation and the image simultaneously.

19. The device of claim 16, further comprising a controller that edits the image in response to the commands of a user.

20. The device of claim 16, further comprising an image capture device that supplies the image to the image capture apparatus.

21. The device of claim 20, wherein the image capture device is a digital camera.

22. The device of claim 16, further comprising a cellular telephone that establishes a communication link between the device and the network.

23. A device comprising:
a receiver that receives an image containing text in a first language over a network;
a translator that generates a translation of the text in a second language; and
a transmitter that transmits the translation over the network.

24. The device of claim 23, further comprising a controller that selects the translator as a function of the first language.

25. The device of claim 23, further comprising an optical character recognition module that extracts the text from the image.

26. A system comprising:
a client device having an image capture apparatus that receives an image containing text in a first language, a client transmitter that transmits the image over a network to a server and a client receiver that receives a translation of the text in a second language over the network from the server; and
the server having a receiver that receives the image over the network from the client, a translator that generates a translation of the text in the second language and a transmitter that transmits the translation over the network to the client.

27. The system of claim 26, the server further comprising an optical character recognition module that extracts the text from the image.
